(19) United States
(12) Patent Application Publication
(10) Pub. No.: US 2009/0300967 A1
(43) Pub. Date: Dec. 10, 2009

(54) METHOD AND SYSTEM FOR A FISHING LURE

(76) Inventor: Jack D. Rainey, Prairie Du Rocher, IL (US)

Correspondence Address: Patent Docket Department;Armstrong Teasdale LLP, One Metropolitan Square, Suite 2600, St. Louis, MO, 63102-2740, US

(21) Appl. No.: 12/133,036

(22) Filed: Jun. 4, 2008

(51) Int. Cl. A01K 85/01

(52) U.S. Cl. 43/42.3; 43/42.53; 43/37

(57) ABSTRACT

A method and system for a fishing lure are provided. The lure includes a body having an interior cavity and an aperture extending through a wall of the body. The fishing lure also includes a hook assembly including at least one hook concealed with the cavity when the hook assembly is in a first retracted position. The hook assembly is maintained in the first retracted position using an elastomeric band coupled to the hook assembly. The hook assembly is rotatable from the first retracted position to a second extended position. The lure also includes an elastomeric attractant coupled to the body.

### BACKGROUND OF THE INVENTION

This invention relates generally to a fishing lure, and more particularly, to a fishing lure that closely resembles a prey animal and that is simply maintainable.

At least some known fishing lures include recessed hooks enclosed within the body of the lure. The hooks are generally deployed using a complex linkage system that reacts to the actions of a fish, the fisherman, or both. Typically, the hooks are set within the body of the lure and triggered such that spring action projects the hooks outwardly and exteriorly from the body to snare the biting fish. Many require intricately designed and machined parts to function, and involved complicated assemblies with many moving pieces. Replacement of broken or deformed components of these lures may be laborious if replacement is even possible given the construction of these lures. Additionally, metallic components within the lure may corrode, fouling the operating mechanism and necessitating replacement of component parts. However, lures having complicated linkages, springs and metallic components make repair more difficult.

### BRIEF DESCRIPTION OF THE INVENTION

In one embodiment, a fishing lure includes a body extending between a forward nose portion and an aft tail portion wherein the body is substantially symmetric about a centerline axis and includes a top half-shell and a bottom half-shell that together enclose an interior volume. The top half-shell includes at least one axial slot therethrough and a lateral slot positioned along a tail edge of the top half-shell. The top half-shell and the bottom half-shell are coupled together using a tab in one of the top half-shell and the bottom half-shell shaped to fit into a complementarily-shaped slot in the other of the top half-shell and the bottom half-shell. The lure further includes a centerplate clamped between the top half-shell and the bottom half-shell in the volume when the body is assembled. The centerplate includes at least one axial slot therethrough in substantial alignment with the top half-shell axial slot and further includes a keyhole aperture. The lure also includes a hook assembly including a hook member coupled to a pivot member wherein the pivot member includes an aperture extending therethrough in an axial direction wherein the hook assembly is concealed within the volume. The lure further includes a unitarily formed bias member including a first interference member, a second interference member, and a resilient elastomeric member extending therebetween wherein the second interference member is sized smaller in diameter than the first interference member.

In another embodiment, method of assembling a fishing lure includes rotatably coupling a hook assembly to a center plate of the fishing lure. The center plate is configured to be positioned at least partially within the fishing lure. The method also includes biasing the hook assembly in a first stowed position using a bias member, the bias member includes an integrally formed first interference member, a second interference member, and a resilient elastomeric member extending therebetween wherein the biasing includes threading the second interference member and the a resilient elastomeric member through an aperture in the hook assembly such that the first end engages the aperture and coupling the second end of the bias member to the centerplate such that the hook assembly is biased in the first position. The method further includes positioning a noise making device in an axial slot of a first portion of a body of the fishing lure, mating the centerplate to the first portion of the fishing lure such that an enclosure is formed about the noise making device, and coupling a second portion of the body to the first portion such that a body interior volume is formed.

In yet another embodiment, a fishing lure includes a body having an interior cavity and an aperture extending through a wall of the body. The fishing lure also includes a hook assembly including at least one hook concealed with the cavity when the hook assembly is in a first retracted position. The hook assembly is maintained in the first retracted position using an elastomeric band coupled to the hook assembly. The hook assembly is rotatable from the first retracted position to a second extended position. The lure also includes an elastomeric attractant coupled to the body.

### BRIEF DESCRIPTION OF THE DRAWINGS

FIGS. 1-6 show exemplary embodiments of the method and system described herein.

FIG. 1 is a perspective view of a fishing lure in accordance with an exemplary embodiment of the present invention;

FIG. 2 is a perspective view of an underside of the upper half shell shown in FIG. 1;

FIG. 3 is a perspective view of a topside of the lower half shell shown in FIG. 1;

FIG. 4A is a rearward axial view of lure in accordance with an exemplary embodiment of the present invention;

FIG. 4B is a side view of the lower half shell in accordance with an exemplary embodiment of the present invention;

FIG. 5 is a perspective view of the centerplate in accordance with an exemplary embodiment of the present invention;

FIG. 6A is a perspective view of a hook assembly that may be used with the lure shown in FIG. 1; and

FIG. 6B is forward end view of the hook assembly looking aft.

### DETAILED DESCRIPTION OF THE INVENTION

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

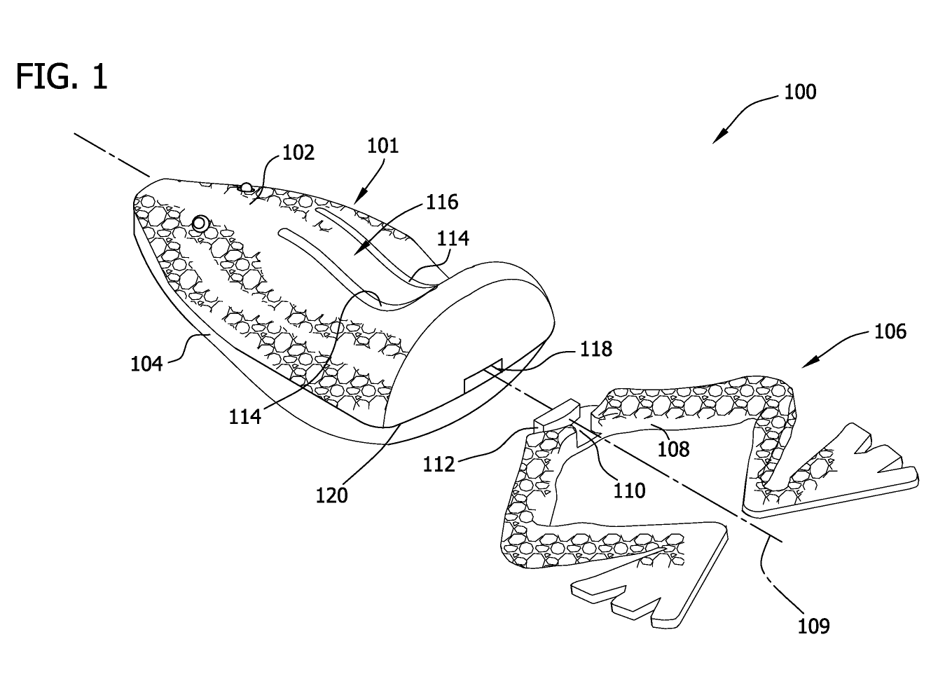

FIG. 1 is a perspective view of a fishing lure 100 in accordance with an exemplary embodiment of the present invention. In the exemplary embodiment, lure 100 includes a body 101 including an upper half shell 102 and a lower half shell 104, and an attractant 106, such as but not limited to a body 108 generally shaped to simulate a prey animal for a fish, for example, frog legs. Lure 100 is generally symmetric about a longitudinal axis 109. In an alternative embodiment, attractant 106 may include a plurality of fronds that also attract a fish, but that do not resemble a natural prey animal. Attractant 106 includes a forward extending rib 110 and an interference member 112 extending away from rib 110. Upper half shell 102 includes at least one slot 114 extending axially along a dorsal area 116 of lure 100. Upper half shell 102 also includes a slot 118 extending along an aft edge 120 of upper half shell 102. Slot 118 is configured to receive rib 110 with interference member 112 positioned within body 101. When fully assembled, attractant 106 is coupled to body 101 by a clamping force exerted between upper half shell 102 and lower half shell 104 on rib 110. Attractant 106 is further secured to body 101 by an interference fit provided between interference member 112 and upper half shell 102.

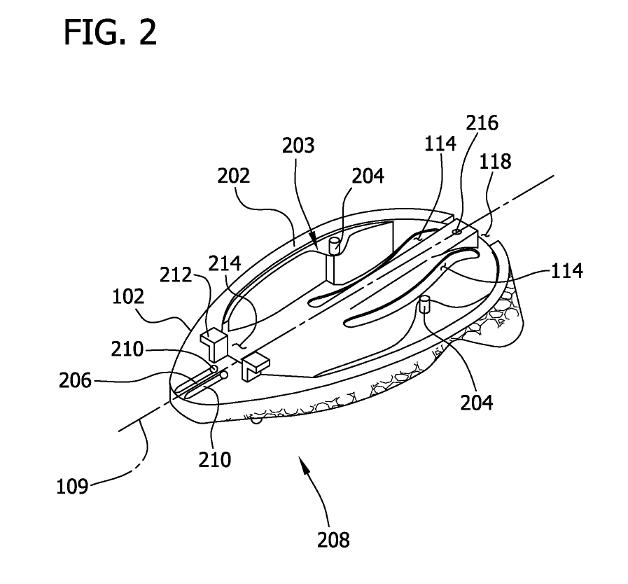

FIG. 2 is a perspective view of an underside 200 of upper half shell 102 (shown in FIG. 1). In the exemplary embodiment, underside 200 includes a substantially planar rim 202 that at least partially circumscribes an interior volume 203 of body 101. Underside 200 includes one or more alignment studs 204 that facilitate lateral stability of upper half shell 102 with respect to lower half shell 104 during assembly and when fully assembled. An axial groove 206 is formed on rim 202 proximate a forward end 208 of upper half shell 102. Groove 206 may be formed between two raised ridges 210 extending axially along rim 202. Underside 200 also includes a T-shaped tab 212 having a central gap 214 in the central leg of the T-shape. Groove 206 and T-shaped tab 212 are configured to cooperate for the free passage of a leader (not shown in FIG. 2) therethrough. A fastener hole 216 is axially aligned proximate slot 118 near aft edge 120.

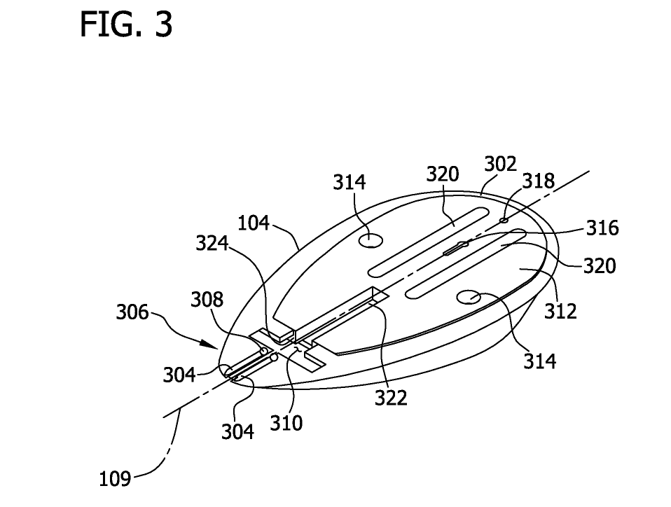

FIG. 3 is a perspective view of a topside 300 of lower half shell 104 (shown in FIG. 1). In the exemplary embodiment, topside 300 includes a substantially planar rim 302 that at least partially circumscribes the interior volume of body 101. Rim 302 is configured to abut rim 202 (shown in FIG. 2) when topside 300 and underside 200 are joined during assembly. Topside 300 includes a pair of slots 304 extending axially along a forward end 306 of lower half shell 104 and a groove 308 formed therebetween. Slots 304 are complementary to ridges 210 (shown in FIG. 2) and configured to receive ridges 210 during assembly. Topside 300 includes a T-slot 310 complementally-shaped to T-shaped tab 212 (shown in FIG. 2). During assembly, T-shaped tab 212 fits into the T-slot 310 such that forward end 306 is secured firmly to forward end 208. A slope of T-slot 310 away from axis 109 draws upper half shell 102 towards lower half shell 104 during assembly when T-shaped tab 212 is inserted into T-slot 310 and slid aftward.

A centerplate 312 is positionable between lower half shell 104 and upper half shell 102. Centerplate 312 may be supported by a shelf (not shown) formed in lower half shell 104 and/or upper half shell 102. One or more laterally spaced apertures 314 are sized and located to receive studs 204 to facilitate alignment and stability of upper half shell 102 and centerplate 312 with respect to lower half shell 104. A keyhole slot 316 is aligned with axis 109. A fastener aperture 318 is positioned to receive a fastener (not shown) extending through lower half shell 104 to fastener hole 216. One or more slots 320 extending axially and in substantial alignment with slots 114 when lure 100 is fully assembled. Slots 320 and 114 facilitate passing at least a portion of respective hooks from interior volume 203 to outside of lure 100. A forward end slot 322 extends aftward from a forward edge 324 of centerplate 312.

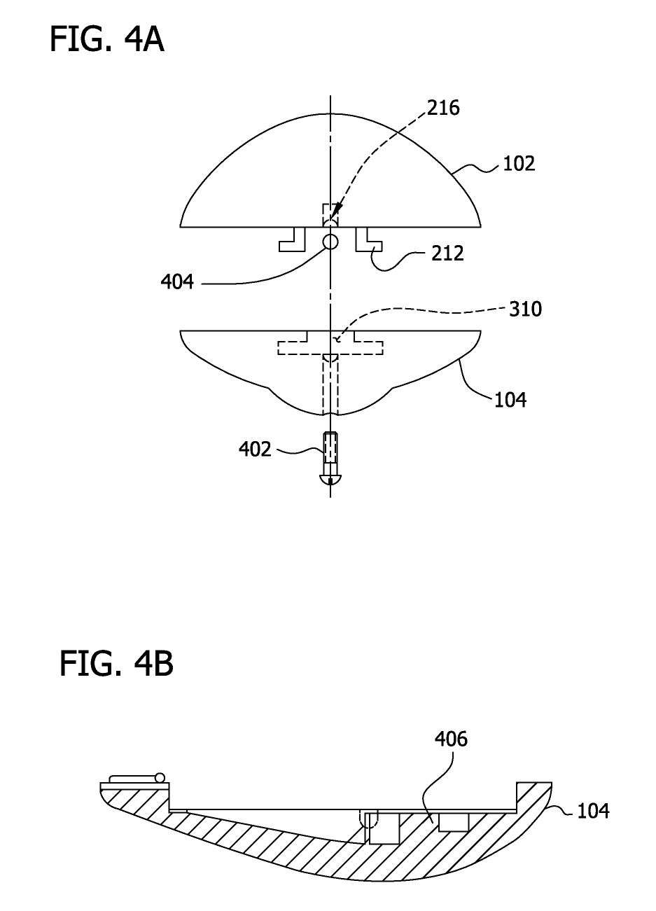

FIG. 4A is a rearward axial view of lure 100 in accordance with an exemplary embodiment of the present invention. FIG. 4B is a side view of lower half shell 104 in accordance with an exemplary embodiment of the present invention. In the exemplary embodiment, tab 212 is aligned and sized to fit within slot 310 and due to the slope of slot 310 away from axis 109, upper half shell 102 is drawn towards lower half shell 104 forming a relative clamping force between upper half shell 102 and lower half shell 104. To secure the coupling between upper half shell 102 and lower half shell 104, a fastener 402, such as but not limited to a threaded screw is threadily engaged to fastener hole 216 through lower half shell 104. When fully assembled, axial grooves 206 and 308 form an aperture through which a leader 404 may pass from interior volume 203 to outside of lure 100. Lower half shell 104 includes an axially aligned cavity 406 sized to receive a generally round or cylindrically-shaped weight 408 sized to provide a ballast to lure 100 to ensure lure 100 is maintained in an upright (upper half shell 102 above lower half shell 104) orientation during retrieval from a cast. An axial length 410 of cavity 406 exceeds an axial dimension 412 of weight 408 such that weight 408 is free to roll in cavity 406 wherein an impact of weight 408 against a front or back sidewall of cavity 406 generates a sound in the water that may be attracting and/or stimulating to a fish.

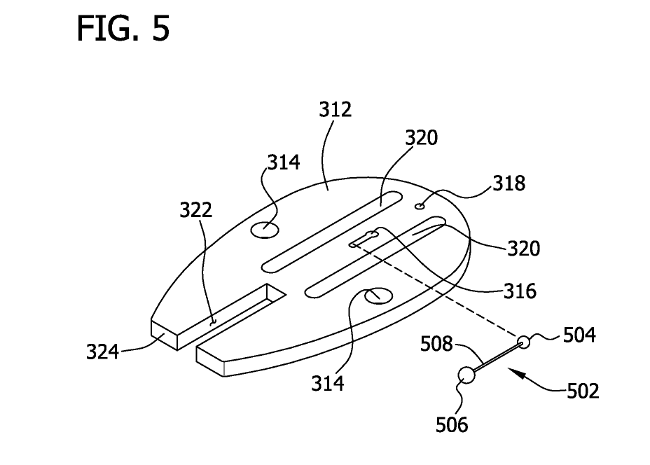

FIG. 5 is a perspective view of centerplate 312 in accordance with an exemplary embodiment of the present invention. In the exemplary embodiment, a bias member 502 includes a first interference member 504, a second interference member 506, and an elastomeric member 508 extending therebetween. In the exemplary embodiment, first interference member 504, second interference member 506, and elastomeric member 508 are integrally formed of the same material and may be formed with attractant 106 with a weak bridge (not shown) extending between bias member 502 and attractant 106 during a forming process. First interference member 504 is sized to fit through a larger portion of keyhole slot 316 but not fit through a smaller slot portion. Second interference member 506 is sized larger than first interference member 504.

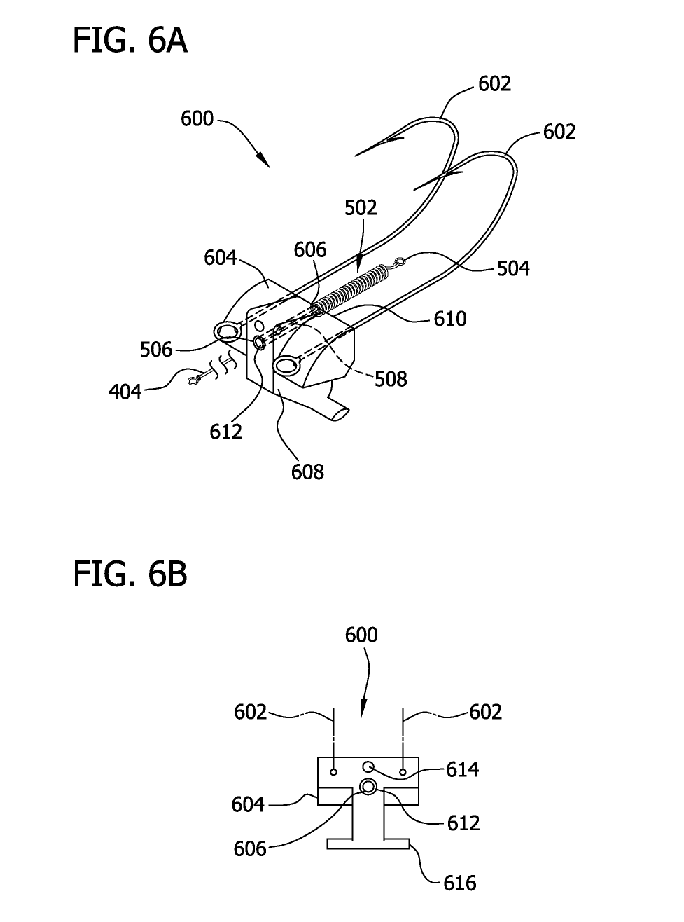

FIG. 6A is a perspective view of a hook assembly 600 that may be used with lure 100 (shown in FIG. 1). FIG. 6B is forward end view of hook assembly 600 looking aft. In the exemplary embodiment, hook assembly 600 includes one or more hooks 602 coupled to or formed with a pivot member 604. A first aperture 606 extends through hook assembly 600 from a forward end 608 to an aft end 610 of hook assembly 600. First aperture 600 is sized to receive first interference member 504 and elastomeric member 508 therethrough, but to not permit second interference member 506 to pass through. Second interference member 506 engages an opening 612 of first aperture 606 on forward end 608. First interference member 504 is sized to engage keyhole slot 316 (shown in FIG. 3). A second aperture is configured to receive leader 404.

Hook assembly 600 includes a T-member 616 extending downwardly away from pivot member 604. T-member 616 is sized and shaped to engage forward end slot 322 (shown in FIG. 3).

During assembly, bias member 502 is threaded through aperture 606 with first interference member 504 passing through opening 612 first followed by elastomeric member 508. Second interference member 506 engages opening 612. T-member 616 is slid into forward end slot 322 such that T-member 616 is one a first side of centerplate 312 and pivot member 604 is on the other side of centerplate 312. First interference member 504 is inserted into keyhole slot 316 and engaged to the narrow portion of keyhole slot 316. A tension force applied to pivot member pivot member 604 biases hook assembly 600 in a first retracted position wherein hook 602 is recessed within body 101. A distal end of leader 404 is inserted through aperture 614 and secured.

During operation, a tension force applied to leader 404 tends to overcome the bias applied to hook assembly 600 by bias member 502 moving hook assembly 600 to a second extended position wherein hook 602 is exposed exteriorly of body 101 for capturing fish.

The above-described embodiments of a method and system for a fishing lure provides a cost-effective and reliable means attracting game fish in a weeded environment while providing for effective means for hooking the fish while biting the lure. As a result, the methods and systems described herein facilitate attracting, stimulating a fish into feeding, and catching the fish all in a weeded environment in a cost-effective and reliable manner.

While the disclosure has been described in terms of various specific embodiments, it will be recognized that the disclosure can be practiced with modification within the spirit and scope of the claims.

What is claimed is:

1. A fishing lure comprising:
a body extending between a forward nose portion and an aft tail portion, said body substantially symmetric about a centerline axis and comprising a top half-shell and a bottom half-shell that together enclose a volume, said top half-shell comprising at least one axial slot therethrough and a lateral slot positioned along a tail edge of said top half-shell, said top half-shell and said bottom half-shell coupled together using a tab in one of said top half-shell and said bottom half-shell shaped to fit into a complementarily-shaped slot in the other of said top half-shell and said bottom half-shell;
a centerplate clamped between said top half-shell and said bottom half-shell in said volume when said body is assembled, said centerplate comprising at least one axial slot therethrough in substantial alignment with said top half-shell axial slot, said centerplate further comprising a keyhole aperture;
a hook assembly comprising a hook member coupled to a pivot member, said pivot member comprising an aperture extending therethrough in an axial direction, said hook assembly concealed within the volume; and
a unitarily formed bias member comprising a first interference member, a second interference member, and a resilient elastomeric member extending therebetween, said second interference member being smaller in diameter than said first interference member.

2. A fishing lure in accordance with claim 1 wherein said top half-shell and said bottom half-shell coupled together using a T-shaped tab in one of said top half-shell and said bottom half-shell shaped to fit tightly into a complementally-shaped T-slot in the other of said top half-shell and said bottom half-shell.

3. A fishing lure in accordance with claim 1 wherein said bias member extends through said aperture in said hook assembly, said first interference member in interfering engagement with said aperture, said second interference member extending through said keyhole aperture in said centerplate.

4. A fishing lure in accordance with claim 1 wherein said pivot member is configured to couple to a fishing line, a force on the fishing line relative to the body is configured to rotate said pivot member about a pivot point extending said hook member at least partially through said top half-shell axial slot.

5. A fishing lure in accordance with claim 1 further comprising an attractant coupled to said body through said lateral slot.

6. A fishing lure in accordance with claim 5 wherein said attractant comprises a rib that is shaped complementary to said lateral slot, said rib comprises an interference tab extending away from said rib.

7. A fishing lure in accordance with claim 1 further comprising a leader coupled to said pivot member.

8. A fishing lure in accordance with claim 1 wherein said body comprises a noise making device configured to generate a noise as a fish attractant.

9. A fishing lure in accordance with claim 8 wherein said noise making device is aligned axially with said body and is further configured as a ballast providing balance.

10. A fishing lure in accordance with claim 8 wherein said noise making device comprises a metal roller.

11. A method of assembling a fishing lure, said method comprising:
rotatably coupling a hook assembly to a center plate of the fishing lure, the center plate configured to be positioned at least partially within the fishing lure;
biasing the hook assembly in a first stowed position using a bias member, the bias member includes an integrally formed first interference member, a second interference member, and a resilient elastomeric member extending therebetween wherein said biasing comprises threading the second interference member and the a resilient elastomeric member through an aperture in the hook assembly such that the first end engages the aperture and coupling the second end of the bias member to the centerplate such that the hook assembly is biased in the first position;
positioning a noise making device in an axial slot of a first portion of a body of the fishing lure;
mating the centerplate to the first portion of the fishing lure such that an enclosure is formed about the noise making device; and
coupling a second portion of the body to the first portion such that a body interior volume is formed.

12. A method in accordance with claim 11 further comprising:
coupling a leader to the hook assembly; and
extending the leader through an aperture in a nose of the body.

13. A method in accordance with claim 11 wherein an attractant includes a rib that is shaped complementary to a lateral slot in a tail of the body and an interference tab extending away from the rib, said method further comprising positioning the attractant with the interference tab within the body interior volume and the rib extending through the lateral slot.

14. A method in accordance with claim 11 wherein coupling a second portion of the body to the first portion comprises:
engaging a tab in one of the first portion and the second portion with a slot in the remaining portion; and
securing the first portion and the second portion using a threaded fastener.

15. A fishing lure system comprising:
a body having an interior cavity and an aperture extending through a wall of said body;
a hook assembly comprising at least one hook concealed with said cavity when said hook assembly is in a first retracted position, said hook assembly maintained in the first retracted position using an elastomeric band coupled to said hook assembly, said hook assembly rotatable from the first retracted position to a second extended position; and
an elastomeric attractant coupled to said body.

16. A system in accordance with claim 15 wherein said elastomeric band comprises a firs

17. A system in accordance with claim 15 wherein said at least one hook extends at least partially through said aperture in said second extended position.

18. A system in accordance with claim 15 wherein said band and said attractant comprise the same material.

19. A system in accordance with claim 15 wherein said band and said attractant are integrally formed.

20. A system in accordance with claim 15 further comprising a centerplate positioned within said interior cavity, said centerplate configured to receive said hook assembly for rotation thereabout, said centerplate comprising a keyhole slot for receiving an attachment end of said band.
